(19) United States
(12) Patent Application Publication
(10) Pub. No.: US 2022/0070261 A1
(43) Pub. Date: Mar. 3, 2022

(54) MONITORING NETWORK FOR VEHICLE

(71) Applicant: International Truck Intellectual Property Company, LLC, Lisle, IL (US)

(72) Inventor: Teik-Khoon Tan, Naperville, IL (US)

(73) Assignee: International Truck Intellectual Property Company, LLC, Lisle, IL (US)

(21) Appl. No.: 17/154,043

(22) Filed: Jan. 21, 2021

Related U.S. Application Data
(60) Provisional application No. 63/073,804, filed on Sep. 2, 2020.

(51) Int. Cl. H04L 29/08

(52) U.S. Cl. CPC H04L 67/12; H04M 1/0202

(57) ABSTRACT

A monitoring network for a vehicle comprises a hub having memory disposed on the vehicle and at least one recycled smartphone having memory disposed at at least one significant location on the vehicle. At least one app resides on the memory of the hub and memory of the at least one recycled smartphone.

### REFERENCE TO RELATED APPLICATIONS

This patent application claims priority from U.S. provisional patent application Ser. No. 63/073,804 filed on Sep. 2, 2020. That application is incorporated herein in its entirety by this reference.

### BACKGROUND

This disclosure relates generally to a monitoring network for a vehicle. More specifically, this disclosure relates to an embodiment of a monitoring network for a vehicle that includes at least one recycled smartphone.

Currently, about 151 million mobile phones, of which smartphones are a member, are discarded each year. Discarded mobile phones contribute to the about 50 million tons of e waste that is generated annually. This is unsustainable.

Some currently available vehicle monitoring networks comprise an operating system and/or a sensor that is unique to that vehicle monitoring network. This limits ability to use elements that are commonly available, thereby increasing cost of those vehicle monitoring networks.

There is a need to reduce discarded mobile phones. There is a need to recycle mobile phones. There is a need to reduce cost of a vehicle monitoring network. These needs may merge.

### SUMMARY

This disclosure relates to embodiments of a monitoring network for a vehicle, such as bus and the like. According to one embodiment, a monitoring network for a vehicle comprises a hub having memory disposed on the vehicle and at least one recycled smartphone having memory disposed at at least one significant location on the vehicle. At least one app resides on the memory of the hub and memory of the at least one recycled smartphone.

### DESCRIPTION OF THE DRAWINGS

FIG. 1 is a block diagram of elements of one embodiment of a monitoring network for a vehicle;

FIG. 2 is a perspective view of an embodiment of an element of the embodiment shown in FIG. 1; and

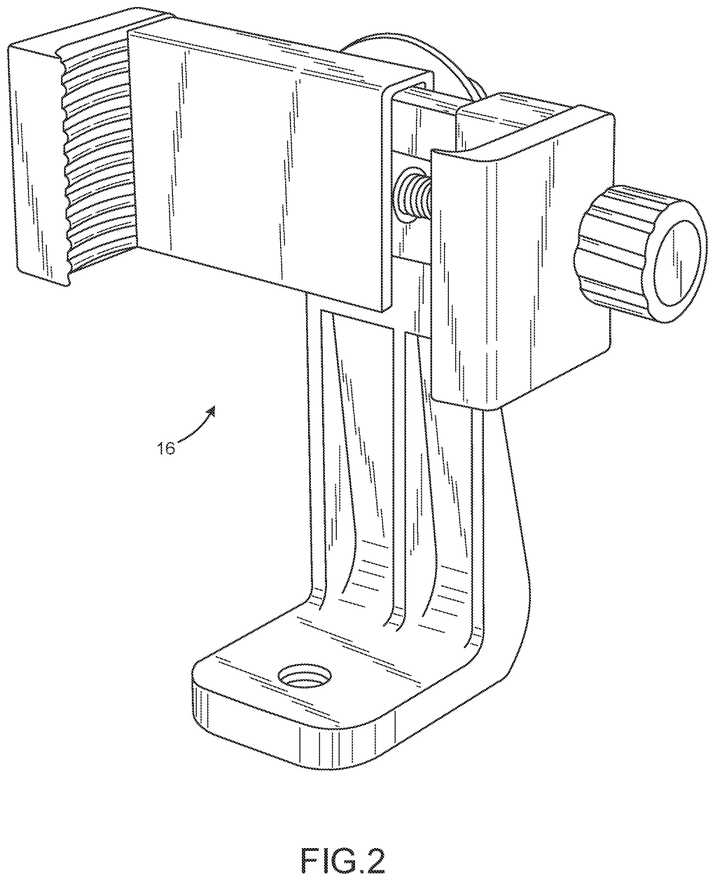

FIG. 3 is a perspective view of another embodiment of the element of FIG. 2; and

FIGS. 4A, 4B and 4C are perspective views of further embodiments of the element of FIG. 2.

### DETAILED DESCRIPTION

This description relates generally to embodiments of a monitoring network for a vehicle, such as a bus and the like. More specifically, this description relates to embodiments of a monitoring network for a vehicle that includes at least one recycled smartphone.

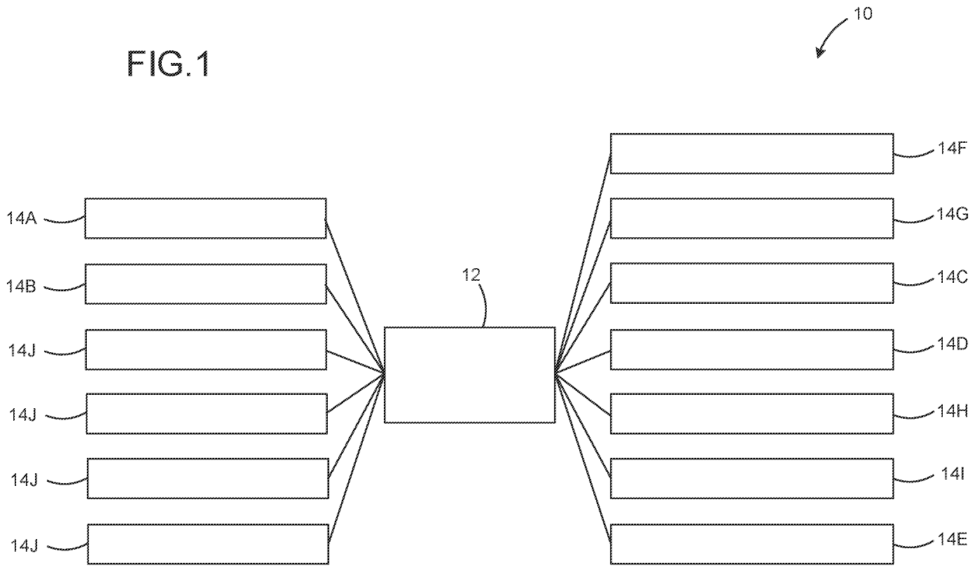

FIG. 1 shows a block diagram for one embodiment of a monitoring network 10 for a vehicle. This embodiment generally comprises a hub 12 connected appropriately, such as wirelessly, USB wiring and the like, with at least one recycled smartphone 14. The hub 12 may be a tablet computer or tablet comprising a USB port, memory, wireless transmitter, wireless receiver, a display or touch screen, a speaker, etc. In some embodiments, the hub 12 may be connected wirelessly to other resources, such as weather alert, traffic alert, a vehicle manager, the internet and the like, that enhance use of a vehicle. In these embodiments, wireless connection of the hub 12 enables omnidirectional communication of the hub 12, thereby allowing data to be sent to and/or transmitted among the hub 12, the vehicle, a central deposit of information, a site available on the internet, appropriate authorities and/or interested people. In some embodiments, the hub 12 may be a smartphone. In some embodiments, the hub 12 operates as a director of the monitoring network 10.

Once a smartphone is discarded, that smartphone can be “cleaned out” by removing unnecessary items from smartphone memory. This produces a recycled smartphone 14. In some embodiments, the at least one recycled smartphone 14 is replaced by a new smartphone, such as a low cost smartphone and the like.

The at least one recycled smartphone 14 includes at least a USB port, a camera with a minimum fifty-five (55) degree viewing angle, such as 1080p wifi camera, a full high definition wifi camera, a one hundred and ten (110) degree wide angle camera and the like, a wireless receiver, a wireless transmitter, a display screen, a microphone and a speaker. At least one app comprising the monitoring network 10 resides on memory of the hub 12 and memory of the at least one recycled smartphone 14. Architecturally, the monitoring network 10 generally comprises central command computing, provided by the hub 12, and distributed edge computing, provided by an expandable network of multiple at least one recycled smartphone 14 wirelessly connected together to monitor intelligently safety functions in a vehicle.

The at least one app includes an operating network and at least one routine. The at least one routine may comprise at least one function selected from: vehicle door pinch alarm; passenger tracker; road condition monitor; road crossing warning; vehicle forward warning; vehicle backward warning; vehicle speed monitor, vehicle operator integrity (drowsiness, checking mirror, eyes on road, etc.) monitor and other functions of interest. Artificial intelligence may be utilized to enhance the at least one routine. The at least one recycled smartphone 14 provides a signal to the app, viz. located in memory on the hub 12 and/or on the at least one recycled smartphone 14, enabling execution of the function. The signal may comprise information, such as audio, visual, thermal and the like, of interest.

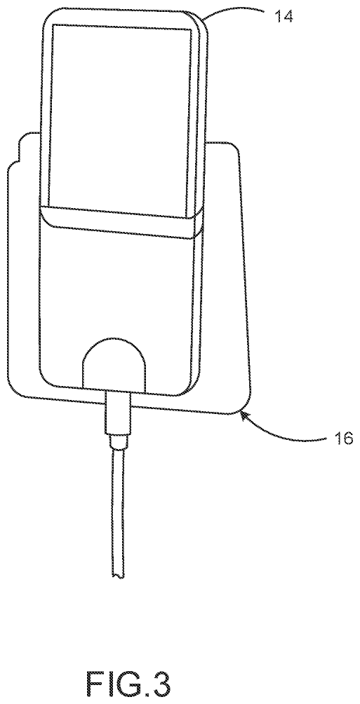

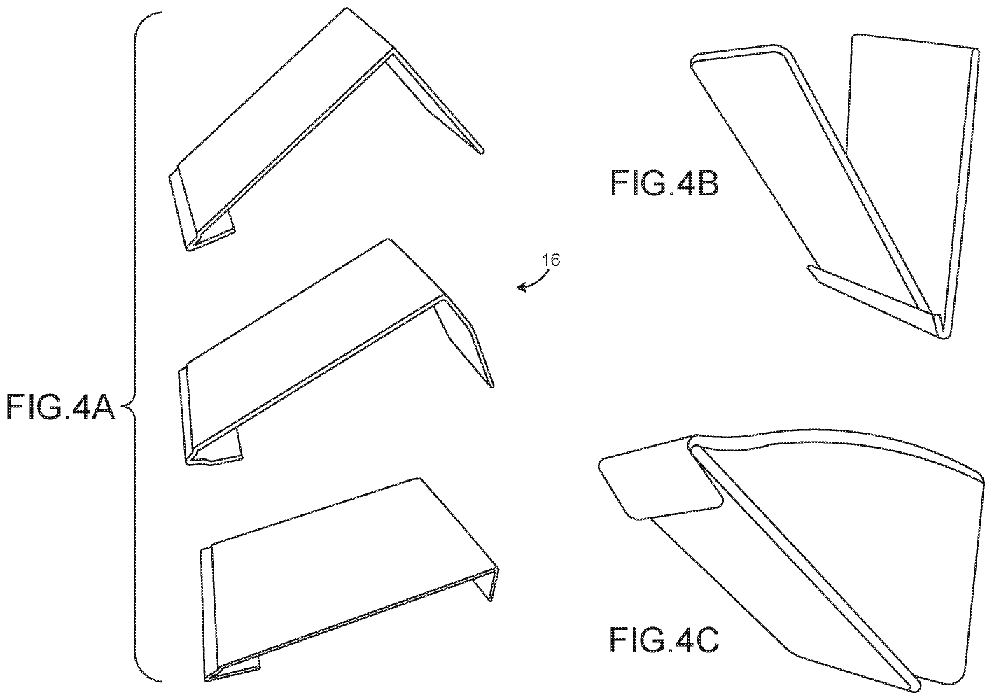

A number of recycled smartphone 14 comprising the monitoring network 10 may depend upon a number of factors, such as but not limited increasing processing speed of the app, increasing bandwidth of the monitoring network 10 and the like. There are thirteen (13) at least one recycled smartphone 14 located at at least one significant location on the vehicle in the embodiment shown in FIG. 1. The at least one significant location on the vehicle may be determined so that the monitoring network 10 appropriately accesses all areas of interest on and/or around a vehicle. The at least one recycled smartphone 14 is positioned at the at least one significant location by a joint 16, such as those shown in FIGS. 3 and 4.

In this embodiment, at least one recycled smartphone 14A is positioned to monitor an operator of the vehicle, at least one recycled smartphone 14B is positioned to monitor a door of the vehicle, at least one recycled smartphone 14C is positioned to monitor an operator side front of the vehicle, at least one recycled smartphone 14D is positioned to monitor a passenger side front of the vehicle, at least one recycled smartphone 14E is positioned to monitor a rear of the vehicle, at least one recycled smartphone 14F is positioned to monitor operator side roadside speed, at least one recycled smartphone 14G is positioned to monitor passenger side roadside speed, at least one recycled smartphone 14H is positioned to monitor operator side curbside top, at least one recycled smartphone 14I is positioned to monitor passenger side curbside top, and at least one recycled smartphone 14J is positioned to monitor vehicle cabin—four (4) at least one recycled smartphone 14J do this. Also, at least one recycled smartphone 14 may be located on a roof of the vehicle, thereby providing a 360 degree view of the vehicle and its surroundings. Precise positions and number of the at least one recycled phone 14 may be determined empirically.

Installation of the hub 12 and at least one recycled smartphone 14 on a vehicle comprises a platform that facilitates development of an app for use with the vehicle. By making the hub 12 and the at least one recycled smartphone 14 standard on the vehicle, effort can focus on app development. With structure of the monitoring network 10 being discussed, now attention is drawn to the at least one app used on the monitoring network 10.

The at least one app may use a signal from the at least one recycled smartphone 14 to detect if an occupant is in distress, such as falling adjacent the door, “pinched” by the door, becoming sick etc. in the vehicle. The signal may comprise audio and visual information regarding condition of the occupant and the door. The at least one app may show this information on a display associated with the hub 12. A speaker on the hub 12 may broadcast audio associated with the signal and thereby with the occupant and the door.

The at least one app may use a signal from the at least one recycled smartphone 14 to count a number of occupants entering and/or leaving the vehicle. The signal may comprise audio and visual information regarding condition of each occupant.

The at least one app may use a signal from the at least one recycled smartphone 14 to perform facial recognition of a vehicle operator and/or occupant. The signal may comprise visual information enabling comparison of that information with visual information from a central deposit of information.

The at least one app may use a signal from the at least one recycled smartphone 14 to detect temperature of a vehicle operator and/or occupant. If a detected temperature exceeds a given value, then the app may alert the vehicle operator and/or necessary authorities to take appropriate action.

The at least one app may use a signal from the at least one recycled smartphone 14 to monitor activity, e.g. fighting, crying, etc. of a vehicle occupant. The signal may include audio and/or visual information. The hub 12 may notify an operator of the vehicle and/or necessary authorities to take appropriate action.

The at least one app may use a signal from the at least one recycled smartphone 14 to detect an inappropriate object, such as a weapon, smoking article and the like, in the cabin of the vehicle. The signal may include audio and/or visual information. The hub 12 may notify an operator of the vehicle and/or necessary authorities to take appropriate action.

The at least one app may use a signal from the at least one recycled smartphone 14 to monitor sanitization of the vehicle. This may occur at any time before, during or after vehicle sanitization. The signal may include audio and/or visual information. The hub 12 may notify an operator of the vehicle and/or responsible people to take appropriate action.

The at least one app may use a signal from the at least one recycled smartphone 14 to monitor condition of a road on which the vehicle is moving. The signal may include audio and/or visual information. The hub 12 may notify an operator of the vehicle and/or necessary authorities to take appropriate action.

The at least one app may use a signal from the at least one recycled smartphone 14 to monitor traffic adjacent the vehicle. The signal may include audio and/or visual information. The hub 12 may notify an operator of the vehicle and/or necessary authorities to take appropriate action such as adjusting route of the vehicle.

The at least one app may use a signal from the at least one recycled smartphone 14 to determine that the vehicle is in an accident. The signal may include audio and/or visual information. The hub 12 may notify an operator of the vehicle and/or necessary authorities to take appropriate action. If the vehicle is in an accident, then the app may start recording output from at least one recycled smartphone 14. That recording may continue for any desired duration, such as thirty (30) seconds and the like.

It can be appreciated that the hub 12 combined with the at least one recycled smartphone 14 comprises a network of many inputs and outputs that enhance use and operation of the vehicle to benefit a vehicle operator and a vehicle occupant. Wireless connection of the monitoring network 10 allows data to be sent to and/or transmitted among the hub 12, the vehicle, a central deposit of information, a site on the internet, appropriate authorities and/or interested people.

What is claimed is:

1. A monitoring network for a vehicle comprises:
a hub having memory disposed on the vehicle;
at least one recycled smartphone having memory disposed at at least one significant location on the vehicle; and
at least one app resident on the memory of the hub and memory of the at least one recycled smartphone.

2. The monitoring network of claim 1 wherein the at least one recycled smartphone includes at least a USB port, a camera, a wireless receiver, a wireless transmitter, a display screen, a microphone and a speaker.

3. The monitoring network of claim 2 wherein the camera has a fifty-five degree viewing angle.

4. The monitoring network of claim 1 wherein the hub comprises central command computing.

5. The monitoring network of claim 1 wherein the at least one recycled smartphone provides distributed edge computing.

6. The monitoring network of claim 1 wherein the at least one recycled smartphone comprises thirteen recycled smartphones located at significant locations on the vehicle.

7. The monitoring network of claim 1 wherein the camera comprises at least one of 1080p wifi camera, a full high definition wifi camera and a one hundred and ten degree wide angle camera.
